(19) United States
(12) Patent Application Publication
(10) Pub. No.: US 2023/0419098 A1
(43) Pub. Date: Dec. 28, 2023

(54) UTILIZING SELECTIVE TRANSFORMATION AND REPLACEMENT WITH HIGH-DIMENSIONALITY PROJECTION LAYERS TO IMPLEMENT NEURAL NETWORKS IN TABULAR DATA ENVIRONMENTS

(71) Applicant: Chime Financial, Inc., San Francisco, CA (US)

(72) Inventors: Anirudh Ravula, San Jose, CA (US); Brian Tsay, San Francisco, CA (US)

(21) Appl. No.: 17/808,910

(22) Filed: Jun. 24, 2022

(51) Int. Cl. G06N 3/08

(52) U.S. Cl. CPC G06N 3/08

(57) ABSTRACT

The present disclosure relates to systems, non-transitory computer-readable media, and methods that utilize transformation and projection layers to implement neural networks in tabular data environments. For example, the disclosed systems identify tabular data sets and segregate measured tabular data values and placeholder tabular data values. In one or more embodiments, the disclosed systems transform the measured tabular data values to a neural network value range based on the distribution of the measured tabular data values. Moreover, the disclosed systems replace placeholder tabular data values with a constant value within the neural network value range. In addition, the disclosed systems identify numerical values and utilize a projection layer to generate feature vectors within a high-dimensionality feature space. In one or more embodiments, the disclosed systems utilize the resulting high-dimensionality tabular data set with a neural network to generate prediction results (e.g., for training and/or inference).

### BACKGROUND

Recent years have seen significant improvements in conventional systems for training and implementing machine learning models. For example, conventional systems utilize a variety of machine learning models with learned parameters trained to perform various prediction tasks. To illustrate, conventional systems utilize decision tree or neural network machine learning approaches to generate predictions or classifications regarding client devices. Although these conventional systems are able to generate and utilize machine learning models, they have a number of technical deficiencies in relation to accuracy, efficiency, and flexibility of implementing computing devices.

For instance, conventional systems often utilize machine learning models that generate inaccurate predictive results. In particular, neural networks that rely on tabular data are often inaccurate due to unique challenges resulting from this form of digital information. For example, tabular data often includes noisy, high-variance information with missing data fields and/or fields with pre-filled values that do not reflect measured information. High-variance input data (e.g., input samples with high values and/or pre-filled tabular data with high values at different scales) can skew weighting parameters within neural networks and lead to model diversions.

In addition, conventional systems are also inefficient. For example, the inaccuracies discussed above often lead to inefficient utilization of computer resources for downstream tasks. To illustrate, conventional systems that utilize machine learning models to generate client device predictions often waste computing resources in interacting with client devices, undermining bandwidth and increasing computer resources. For example, conventional systems that utilize AI-powered chat bots often generate excessive digital communications that increase time and computer resources utilized to interact with client devices over computer networks.

In addition, conventional systems are often inflexible and rigid. For example, as mentioned above, conventional systems that utilize neural networks are often unable to accommodate different types of digital information, such as tabular data sources. Indeed, this inflexibility often leads conventional systems to utilize only particular machine learning model architectures, such as decision trees, in processing tabular data.

### SUMMARY

This disclosure describes one or more embodiments of methods, non-transitory computer-readable media, and systems that can solve the foregoing problems in addition to providing other benefits by utilizing selective transformation and replacement with high-dimensionality projection layers to implement neural networks in tabular data environments. For example, in one or more implementations the disclosed systems identify tabular data sets and segregate measured tabular data values (e.g., data values reflecting actual measured digital information) and placeholder tabular data values (e.g., missing or unmeasured, proxy data values within the tabular data structure). In one or more embodiments, the disclosed systems isolate and transform the measured tabular data values to a neural network value range based on the distribution of the measured tabular data values. Moreover, the disclosed systems replace placeholder tabular data values with a mean metric (or other constant value) within the neural network value range. In addition, the disclosed systems identify resulting numerical values from the transformed tabular data set and utilize a projection layer to generate feature vectors within a high-dimensionality feature space. In one or more embodiments, the disclosed systems utilize the resulting high-dimensionality tabular data set with a neural network to generate prediction results (e.g., for training and/or inference). In this manner, the disclosed systems improve the accuracy, efficiency, and flexibility of neural networks and implementing computing devices.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a block diagram of an environment for implementing a machine- learning platform system in accordance with one or more embodiments.

FIG. 2 illustrates an example diagram of transforming a tabular data set and generating a prediction utilizing the transformed tabular data set and a neural network in accordance with one or more embodiments.

FIG. 3 illustrates an example diagram of generating a transformed tabular data set in accordance with one or more embodiments.

FIG. 4 illustrates an example diagram of generating a high-dimensionality tabular data set in accordance with one or more embodiments.

FIG. 5 illustrates an example diagram of training a neural network utilizing a transformed/high-dimensionality tabular data set in accordance with one or more embodiments.

FIG. 6 illustrates a diagram of utilizing a trained neural network to generate predicted client disposition classifications and generate automated client interaction responses in accordance with one or more embodiments.

FIG. 7 illustrates a diagram of experimental results regarding the accuracy of an example neural network trained and implemented in accordance with one or more embodiments.

FIG. 8 illustrates an example series of acts for utilizing a neural network and a high-dimensionality tabular data set to generate a prediction in accordance with one or more embodiments.

FIG. 9 illustrates a block diagram of a computing device for implementing one or more embodiments of the present disclosure.

FIG. 10 illustrates an example environment for an inter-network facilitation system in accordance with one or more embodiments.

### DETAILED DESCRIPTION

This disclosure describes one or more embodiments of a machine-learning platform system that utilizes a transformation and replacement layer with a high-dimensionality projection layer to implement neural networks with tabular data sets. For example, the machine-learning platform system identifies measured tabular data values and placeholder tabular data values within a tabular data set. In one or more implementations, the machine-learning platform system determines a mean and deviation metric for the measured tabular data values and transforms the measured tabular data values to a neural network value range. In addition, the machine-learning platform system identifies a constant value (e.g., a mean metric) within the neural network value range and replaces the placeholder tabular data values with the constant value to generate a transformed tabular data set. Moreover, in one or more implementations, the machine-learning platform system extracts numerical values from the transformed tabular data set and utilizes a projection layer to project the numerical values to a high-dimensionality feature space. In some embodiments, the machine-learning platform system also applies a normalization layer to the feature vectors to generate a high-dimensionality tabular data set. From this high-dimensionality tabular data set, the machine-learning platform system utilizes the remaining layers of a neural network to generate improved prediction results. In this manner, the disclosed systems improve the accuracy, efficiency, and flexibility of computing devices in training and implementing neural networks.

As just mentioned, the machine-learning platform system identifies tabular data sets and extracts measured tabular data values and placeholder tabular data values. For example, the machine-learning platform system identifies measured tabular data values that reflect digital information observed, measured, recorded for a client device or account. Similarly, the machine-learning platform system identifies placeholder tabular data values that are unmeasured, but reflect missing or unmeasured, proxy values.

In one or more embodiments, the machine-learning platform system transforms these tabular data sets to improve operation of a neural network. For example, the machine-learning platform system removes the placeholder tabular data values and transforms the measured tabular data values to a neural network range based on a distribution of the measured tabular data values. For instance, the machine-learning platform system determines a mean and distribution metric of measured tabular data values and transforms the measured tabular data values to the neural network range utilizing the mean and the distribution metric. In addition, the machine-learning platform system replaces the placeholder tabular data values. For example, the machine-learning platform system identifies a constant value (e.g., a transformed mean value) within the neural network range and replaces the placeholder tabular data values with the constant value.

In one or more implementations, the machine-learning platform system also generates high-dimensionality tabular data sets from the transformed data sets. For example, the machine-learning platform system extracts numerical values from a transformed data set and utilizes a projection layer to generate feature vectors within a high-dimensionality feature space. Thus, the machine-learning platform system maps an input value (e.g., having a single dimensionality) into a feature vector of a second dimensionality (e.g., having a higher dimensionality than the input value). In some implementations, the machine-learning platform system also applies an L2 normalization to the generated feature vectors. The machine-learning platform system then utilizes these normalized feature vectors and the neural network to generate predicted results.

The machine-learning platform system can utilize this approach to both train and implement neural networks. For example, in training, the machine-learning platform system can compare predicted results to a training ground truth (utilizing a loss function) and modify parameters of the neural network. In some implementations, the machine-learning platform system further utilizes multiple regularization approaches to more accurately train the neural network. For example, in one or more embodiments, the machine-learning platform system utilizes both dropout regularization and L2 regularization in training the neural network.

As just mentioned, the disclosed machine-learning platform system provides several improvements or advantages over conventional systems. For example, the machine-learning platform system can improve accuracy relative to conventional systems by utilizing transformed/high-dimensionality tabular data sets in conjunction with neural networks to generate more accurate prediction results. Indeed, by transforming tabular data into a neural network range based on the distribution of isolated, measured tabular data values, the machine-learning platform system can reduce variability in the tabular data that can skew neural network weights. Moreover, by replacing placeholder tabular data values with a constant value within the neural network value range, the machine-learning platform system can correct filled/missing data values that cause deviation in neural networks for conventional systems. Furthermore, by utilizing a projection layer (and normalization layer) to generate feature vectors in a high-dimensionality feature space from numerical value feature representations, the disclosed systems improve accuracy in analyzing numerical values from tabular data sets. In addition, the machine-learning platform system further improves accuracy by utilizing both dropout regularization and L2 regularization in training. Indeed, as discussed in greater detail below, researchers have measured performance improvements of over 20% in applying experimental embodiments of the machine-learning platform system relative to conventional systems.

In addition, the machine-learning platform system can improve inefficiencies of conventional systems by reducing the overall burden on implementing devices. For example, by generating more accurate prediction results, the machine-learning platform system can significantly reduce computer resources. For example, the machine-learning platform system can utilize a trained machine learning model to generate predicted client intent classifications and generate automated interaction responses (such as selectable digital text reply options for client devices). Accordingly, the machine-learning platform system can reduce interaction times, user interfaces, and computing resources in interacting with client devices.

The machine-learning platform system can also improve the inflexibility and rigidity of conventional systems. For example, the machine-learning platform system can flexibly accommodate a variety of digital inputs, including tabular data sets that include numerical or categorical data. In addition, the machine-learning platform system can utilize neural networks that process non-tabular data, such as pixel values for digital images. Accordingly, the machine-learning platform system expands the functionality of implementing computing devices to allow accurate neural network analysis of tabular data sets in addition to other digital information.

As indicated by the foregoing discussion, the present disclosure utilizes a variety of terms to describe features and advantages of the machine-learning platform system. For example, as used herein, the term “tabular data set” refers to digital information stored in a tabular form. For instance, a tabular data set can include digital information stored in rows and/or columns (e.g., a table, array, or matrix) reflecting measured features or characteristics (e.g., of an account, client device, or user). To illustrate, a tabular data set can include digital information regarding user features (e.g., age, address, income), client device features (e.g., device model, download speeds, application access time) or account features (e.g., account balance, direct deposit amount, account access time). Tabular data sets include measured tabular data values that indicate an identified metric for a tabular data cell, feature, or characteristic (e.g., a measured age or measured account balance). Tabular data sets can also include placeholder tabular data values that reflect missing or unmeasured features or characteristics. Thus, for example, if the age or account balance of a user is unknown, a tabular data set can include a placeholder tabular data value for the unknown value (e.g., an unmeasured, proxy tabular data value of 1 billion, or some other value).

As mentioned, the machine-learning platform system can implement a variety of machine learning models. As used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

As used herein, the term “neural network” refers to a machine learning model of interconnected artificial neurons (e.g., organized in layers) that communicate and learn to approximate complex functions and generate outputs based on a plurality of inputs provided to the neural network. In some cases, a neural network refers to an algorithm (or set of algorithms) that implements deep learning techniques to model high-level abstractions in data. For example, a neural network includes a multi-layer perceptron, a transformer neural network, a convolutional neural network, a recurrent neural network (e.g., an LSTM), a graph neural network, or a generative adversarial neural network.

As mentioned above, in some implementations, the machine-learning platform system transforms measured tabular data values to a neural network value range. As used herein, the term “neural network value range” refers to a range of data values for utilization within a neural network. For example, the machine-learning platform system can utilize a distribution (e.g., metrics defining a Gaussian distribution or other distribution of values) to map measured tabular data values to a neural network value range. In some embodiments, the machine-learning platform system utilizes a mean (e.g., average, including a mean, median, or mode) and a deviation metric (e.g., a dispersion, standard deviation, average absolute deviation, medium absolute deviation, or maximum absolute deviation) to transform the measured tabular data values to the neural network value range.

In addition, the machine-learning platform system can also replace placeholder tabular data values with a constant value within a neural network value range. For example, this constant value can include a transformed mean metric. Thus, for example, if the machine-learning platform system transforms measured tabular data values to neural network value range centered at a particular value, the machine-learning platform system can map the placeholder tabular data values to this value.

As mentioned above, the machine-learning platform system utilizes a projection layer to generate feature vectors for numerical values of a tabular data set. As used herein, the term “projection layer” refers to a computer-implemented algorithm function or function that generates feature vectors from input data into a multi-dimensional feature space. For example, a projection layer can include a projection algorithm, such as a matrix multiplication function or neural network layer with learned weights for projecting input values into the multi-dimensional feature space. Thus, the projection layer can analyze a one-dimensional input value and generate a feature vector (e.g., individual vector representation that reflects latent features of the input value) having a higher dimensionality than the input value (e.g., a feature vector with five values that define a location, point, or region within a five-dimensional feature space). The projection layer can be pre-configured (e.g., prior to training) or the projection layer can be configured at the time of training.

As mentioned above, the machine-learning platform system can also utilize a normalization layer. As used herein, a normalization layer refers to a computer-implemented algorithm or function to modify data values (e.g., vectors) based on their magnitude, size, or distance to control variability across the data values. For example, a normalization layer can include determining and applying a vector L1 norm, L2 norm, max norm, or other normalization value to input vectors. As discussed in greater detail below, in some implementations, the machine-learning platform system implements a normalization layer by dividing feature vectors by the corresponding L2 norm of each vector.

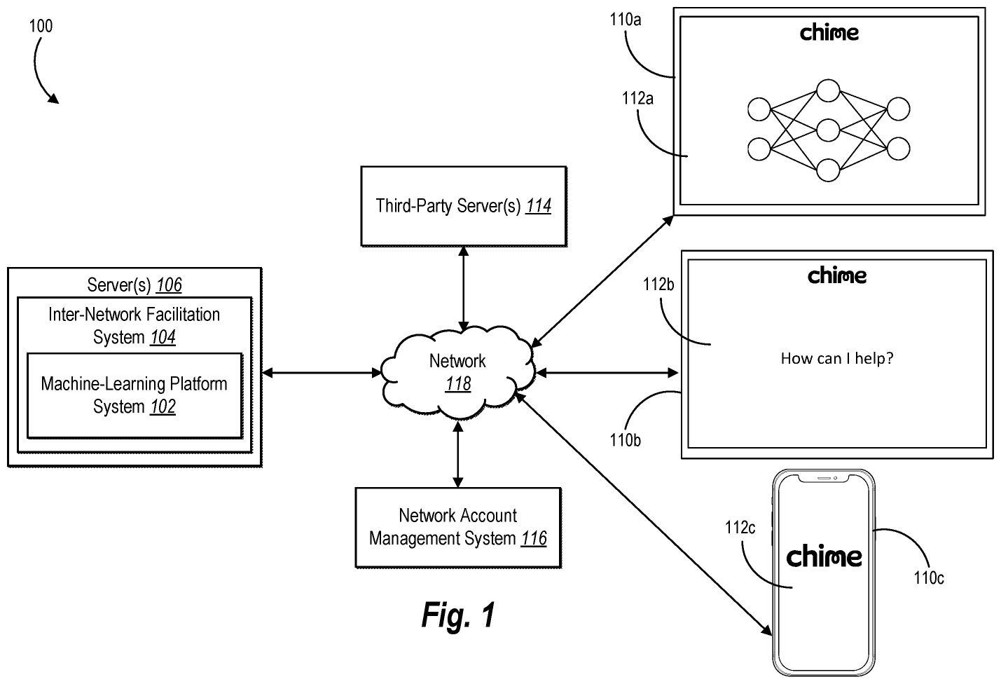

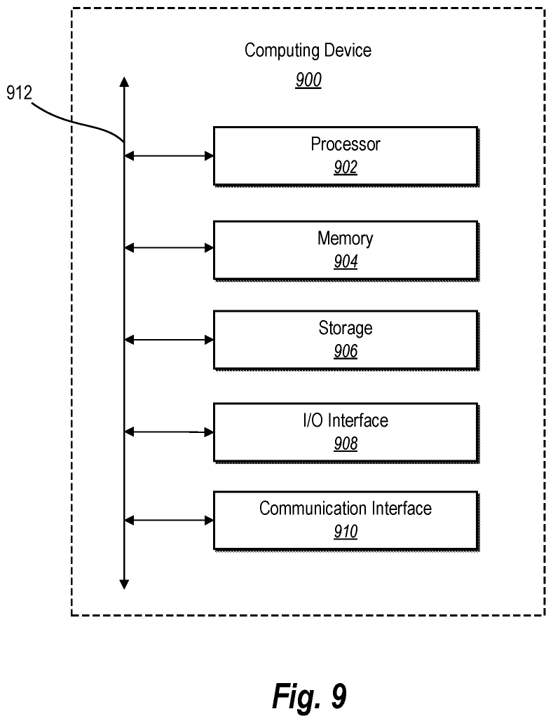

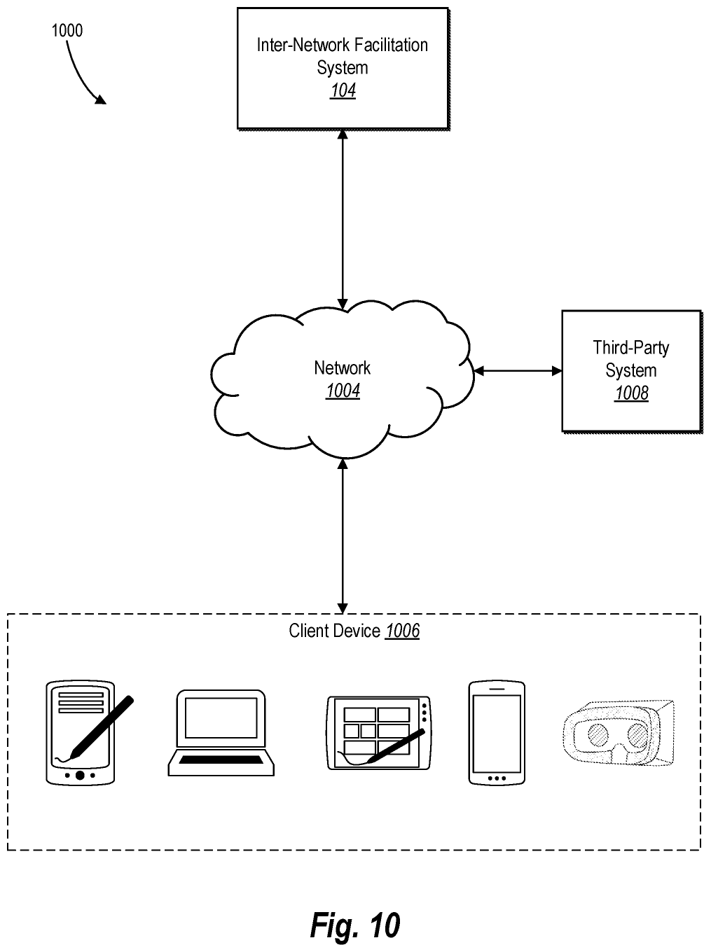

Additional detail regarding the machine-learning platform system will now be provided with reference to the figures. In particular, FIG. 1 illustrates a computing system environment for implementing a machine-learning platform system 102 in accordance with one or more embodiments. As shown in FIG. 1, the environment includes server(s) 106, a variety of client devices (e.g., model engineering device(s) 110a, agent device(s) 110b, and client device(s) 110c), third-party server(s) 114, and a network account management system 116. Each of the components of the environment 100 communicate (or are at least configured to communicate) via the network 118, and the network 118 may be any suitable network over which computing devices can communicate. Example networks are discussed in more detail below in relation to FIGS. 9-10.

As further illustrated in FIG. 1, the environment 100 includes the server(s) 106. In some embodiments, the server(s) 106 comprises a content server, a historical data (feature store) server, and/or a data collection server. Additionally or alternatively, the server(s) 106 comprise an application server, a communication server, a web-hosting server, a social networking server, a digital content management server, a machine-learning model development server, or a financial payment server.

Moreover, as shown in FIG. 1, the server(s) 106 implement an inter-network facilitation system 104. As described in greater detail below (e.g., in relation to FIG. 10), the inter-network facilitation system 104 can manage interactions across multiple devices, providers, and computer systems. For example, the inter-network facilitation system 104 can execute transactions across various third-party systems such as a banking entities, automated transaction machines, or payment providers. The inter-network facilitation system 104 can also maintain and manage digital accounts for client devices/users to store, manage, and/or transfer funds to other users.

Further, the environment 100 includes a variety of client devices, including the model engineering device(s) 110a, the agent device(s) 110b, and the client device(s) 110c. These client devices can include one of a variety of computing devices, including a smartphone, tablet, smart television, desktop computer, laptop computer, virtual reality device, augmented reality device, or other computing device as described in relation to FIGS. 9-10. Although FIG. 1 illustrates only a single instance of these client devices, the environment 100 can include many different client devices connected to each other via the network 118 (e.g., as denoted by the separating ellipses).

Further, in some embodiments, model engineering device(s) 110a assist in generating and managing machine learning models for the machine-learning platform system 102. For example, the machine-learning platform system 102 can provide user interfaces illustrating machine learning model parameters, training/implementations pipelines, and/or containers for selection/modification by the model engineering device(s) 110a. The machine-learning platform system 102 can utilize the preferences, settings, parameters, and training data identified by the model engineering device(s) 110a to train or implement a machine learning model.

During inference time, the machine-learning platform system 102 can interact with the client device(s) 110c to identify features and generate/provide predictions. For example, in implementing a fraud detection machine learning model, the machine-learning platform system 102 can train the fraud detection machine learning model (based on information monitored from accounts and/or previous client interactions), identify features of the client device(s) 110c, and predict whether the client device(s) 110c is fraudulently attempting to access or utilize a digital account corresponding to the inter-network facilitation system 104. Similarly, in implementing an automated client interaction machine learning model, the machine-learning platform system can extract features regarding the client device(s) 110c, and utilize the machine learning model to generate an automated interaction response for the client device(s) 110c.

The machine-learning platform system 102 can also interact with the agent device(s) 110b. For example, the machine-learning platform system 102 can provide digital information to the agent device(s) 110b regarding the client device(s) 110c or a corresponding client. To illustrate, the machine-learning platform system 102 can provide digital information regarding a predicted client intent/disposition to aid the agent device(s) 110b in providing digital information to the client device(s) 110c.

Moreover, as shown, the client devices include corresponding client applications 112a-112c. The client applications 112a-112c can each include a web application, a native application installed on the client devices 110a-110c (e.g., a mobile application, a desktop application, a plug-in application, etc.), or a cloud-based application where part of the functionality is performed by the server(s) 106. In some embodiments, the machine-learning platform system 102 causes the client applications 112a-112c to present or display information to a user associated with the client devices 110a-110c, including information relating to one or more different pre-defined model container workflows or machine learning model inferences.

Further shown in FIG. 1, the environment 100 includes the third-party server(s) 114. In one or more embodiments, the third-party server(s) 114 include one or more servers for data repositories, testing platforms, integration/delivery (CI/CD) platforms, etc. Accordingly, the third-party server(s) 114 can communicate with the client devices 110a-110c and/or the machine-learning platform system 102 to provide certain inputs for training or implementing machine learning models.

In addition, the machine-learning platform system 102 can communicate with the network account management system 116 regarding one or more network transactions. For example, the machine-learning platform system 102 can communicate with the network account management system 116 to identify one or more of transaction data, network account data, device data corresponding to consumer client devices, etc.

In some embodiments, though not illustrated in FIG. 1, the environment 100 has a different arrangement of components and/or has a different number or set of components altogether. For example, in certain embodiments, the client devices 110a-110c communicate directly with the server(s) 106, bypassing the network 118.

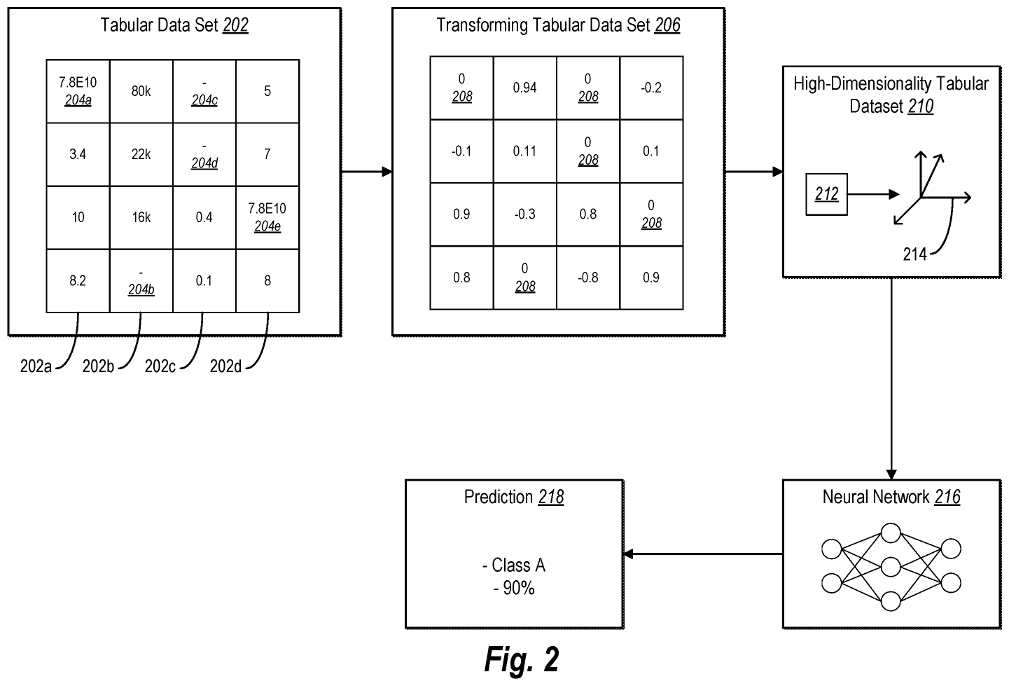

As discussed above, the machine-learning platform system 102 can generate transformed/high-dimensionality tabular data sets for utilization with a neural network to generate predictions. FIG. 2 illustrates the machine-learning platform system 102 processing a tabular data set 202 and generating a prediction 218 utilizing a neural network 216 in accordance with one or more embodiments.

As shown in FIG. 2, the machine-learning platform system 102 identifies a tabular data set 202. With regard to FIG. 2, the tabular data set 202 includes rows and columns that reflect different features. For example, the first row of the tabular data set 202 includes a first set of features for different client devices (e.g., average number of application sessions in the past month). Similarly, a second row of the tabular data set 202 includes a second set of features for different client devices (e.g., annual direct deposit for a digital account corresponding to the client device). Moreover, the third and fourth rows of the tabular data set 202 include a third set of features and fourth set of features across client devices.

As illustrated, the tabular data set 202 includes measured tabular data values (e.g., 3.4, 10, 8.2, 80 k, etc.). These data values reflect information gathered, observed, or measured by the machine-learning platform system 102 (or another system). The tabular data set 202 also includes placeholder tabular data values 204a-204e. These data values do not reflect information observed or measured by the machine-learning platform system 102 but missing/filled/proxy information utilized to populate the tabular data set 202 in the absence of measured tabular data values.

As illustrated, the machine-learning platform system 102 can identify placeholder tabular data values 204a-204e in a variety of forms. For example, the placeholder tabular data values 204a, 204e include unmeasured, proxy tabular data values that are significantly higher than other values within the tabular data set 202. Indeed, in some circumstances, tabular data sets include these significantly higher values for fields with missing or unpopulated data metrics. Similarly, the tabular data set 202 includes placeholder tabular data values 204b-204d (e.g., indicated by a “-” symbol). The tabular data set can identity placeholder tabular data values that are blank or designated by some other value or metric (e.g., “0,” “N/A,” etc.).

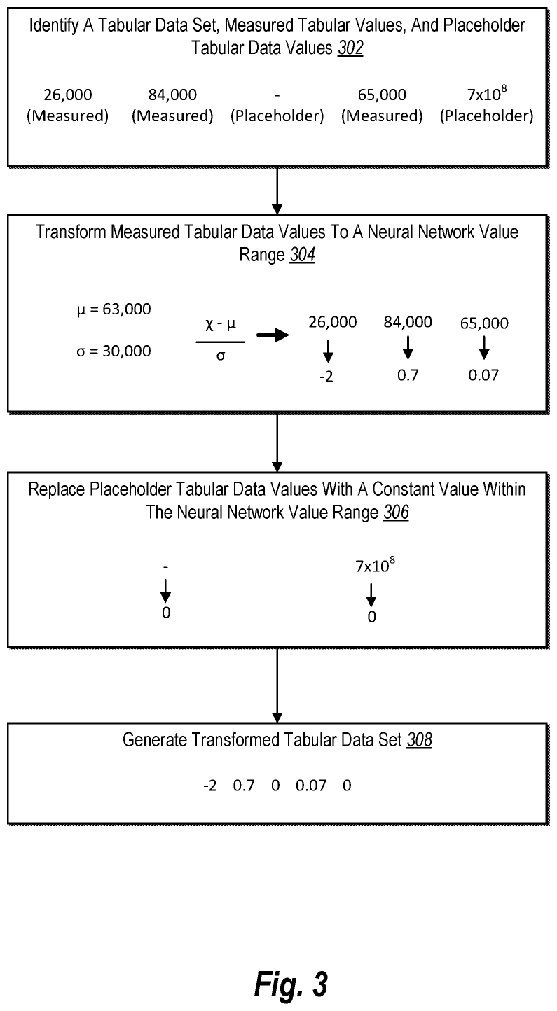

As shown, the machine-learning platform system 102 generates a transformed tabular data set 206 from the tabular data set 202. In particular, the machine-learning platform system 102 excludes the placeholder tabular data values and transforms the measured tabular data values from the tabular data set 202 based on a distribution of the measured tabular data values. For instance, for the measured tabular data values in the first column 202a of the tabular data set, the machine-learning platform system 102 determines a distribution and transforms the measured tabular data values to a neural network range based on the distribution. Similarly, the machine-learning platform system 102 performs a similar operation with regard to the second column 202b, the third column 202c, and the fourth column 202d. Moreover, the machine-learning platform system 102 replaces the placeholder tabular data values 204a-204d with a constant value 208 within the neural network range (e.g., at a transformed mean metric of the neural network range). Additional detail regarding generating a transformed tabular data set is provided below (e.g., in relation to FIG. 3).

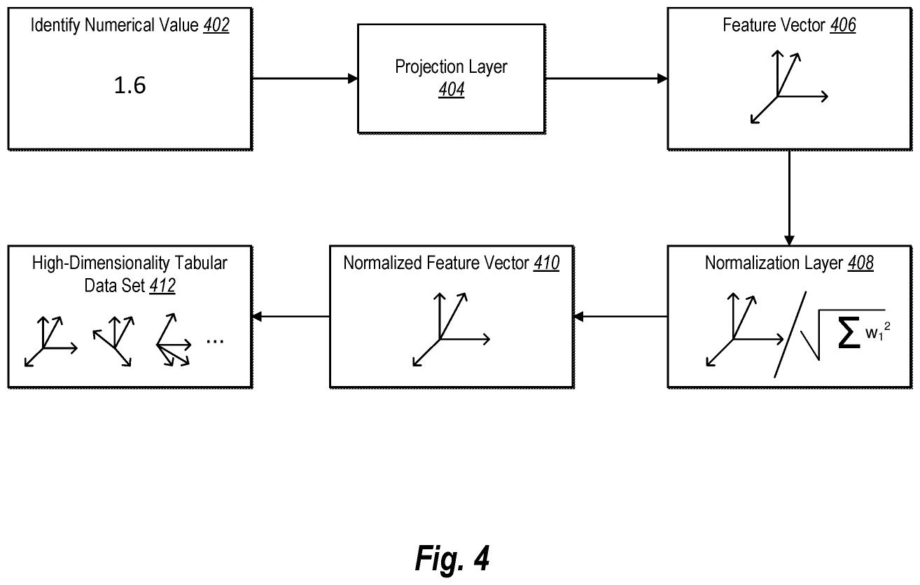

The machine-learning platform system 102 also generates a high-dimensionality tabular data set 210 from the transformed tabular data set 206. Indeed, as shown, the machine-learning platform system 102 extracts a numerical value 212 from the transformed tabular data set 206. The machine-learning platform system 102 utilizes a projection layer to project the numerical value 212 to a multi-dimensional feature space. Specifically, the machine-learning platform system 102 generates a feature vector 214 that represents the numerical value 212 within the high-dimensional space. In some implementations, the machine-learning platform system 102 also applies a normalization layer to the feature vector 214. Additional detail regarding utilizing a projection layer/normalization layer to generate a high-dimensionality tabular data set is provided below (e.g., in relation to FIG. 4).

As further shown in FIG. 2, the machine-learning platform system 102 utilizes the neural network 216 to generate the prediction 218. In particular, the machine-learning platform system 102 utilizes internal weights/parameters of the neural network 216 to process the high-dimensionality tabular data set 210. As shown, in one or more implementations, the prediction 218 includes a classification and corresponding classification probability (e.g., Class A, with a confidence value of 90%). In some implementations, the prediction 218 includes a different type of prediction.

Although FIG. 2 illustrates the tabular data set 202 with all numerical values, in some embodiments, the machine-learning platform system 102 can analyze a tabular data set with various types of information. For example, in some embodiments, the tabular data set 202 includes numerical values and categorical information. For example, the tabular data set 202 could include a location (e.g., state or city of residence), device type, operating system, or other categorical classification. In some embodiments, the machine-learning platform system 102 embeds these categories (e.g., one-hot encoding for each class), and processes these embeddings utilizing the neural network 216 (e.g., without the transformation and projection processes described above).

As mentioned above, in some embodiments, the machine-learning platform system 102 generates a transformed tabular data set from a tabular data set for a neural network. For example, FIG. 3 illustrates a series of acts 302-308 in generating a transformed data set from a tabular data set in accordance with one or more embodiments.

As illustrated, the machine-learning platform system 102 performs an act 302 of identifying a tabular data set with measured tabular data values and placeholder tabular data values. As discussed with regard to FIG. 2, the machine-learning platform system 102 identifies measured tabular data values as those data values observed or extracted regarding a client device, client, and/or account. In some embodiments, the machine-learning platform system 102 identifies the placeholder tabular data values as unmeasured, proxy data values and/or missing data values. For example, the machine-learning platform system 102 identifies a placeholder tabular data values by searching for particular numbers/text/values (e.g., “-”, “0,” or “N/A”).

In some implementations, the machine-learning platform system 102 identifies placeholder tabular data values as those values above or below a set of thresholds. For example, the machine-learning platform system 102 identifies a maximum threshold for a particular feature and identifies any value above the maximum threshold as a placeholder tabular data value. For example, the machine-learning platform system 102 identifies the placeholder tabular data value (e.g., 7.8×10¹⁰) as being above a maximum threshold for a salary feature.

As illustrated, the machine-learning platform system 102 also performs an act 304 of transforming measured tabular data values to a neural network value range. In particular, the machine-learning platform system 102 excludes (e.g., removes or ignores) the placeholder tabular data values at the act 304 and transforms the remaining measured tabular data values to the neural network value range. As discussed above with regard to FIG. 2, the machine-learning platform system 102 can utilizes a distribution of the measured tabular data to perform this transformation. For example, with regard to FIG. 3, the machine-learning platform system 102 utilizes a mean of the measured tabular data values (indicated as μ) and a deviation metric of the measured tabular data values (indicated as σ) to transform the measured tabular data values. In one or more embodiments, the machine-learning platform system 102 utilizes the unweighted average as the mean and the standard deviation as the deviation metric. As mentioned above, the machine-learning platform system 102 can utilize a variety of mean metrics or deviation metrics. In one or more implementations, the machine-learning platform system 102 utilizes the following equation,

$$v = \frac{x - μ}{σ}$$

to determine the transformed value, v, of each measured tabular data value, x.

Thus, as shown, the machine-learning platform system 102 transforms the measured tabular data values (26,000, 84,000, and 65,000) to transformed data values (−2, 0.7, and 0.07) having a reduced neural network range (−2 to 0.7) relative to the original range (26,000 to 84,000).

Although the act 304 illustrated in FIG. 3 illustrates a particular transformation and neural network range, the machine-learning platform system 102 can utilize a variety of different transformations. For example, in some embodiments, the machine-learning platform system 102 transforms the measured data values to a neural network range between 0 and 1 (or between 0 and 100).

Moreover, as illustrated in FIG. 3, the machine-learning platform system 102 also performs an act 306 of replacing placeholder tabular data values with a constant value with the neural network value range. In one or more embodiments, the machine-learning platform system 102 selects a transformed mean metric within the neural network value range as the constant value. For example, with regard to the embodiment of FIG. 3, the transformed mean metric of the neural network range is a value of “0.” Indeed, replacing x with the mean μ in the equation above results in a value of “0.” Thus, the value “0” reflects a mean of the transformed measured tabular data values.

As mentioned above, the machine-learning platform system 102 can utilize a variety of mean metrics and neural network value ranges. Moreover, the machine-learning platform system 102 can also select a constant value that does not reflect a transformed mean metric. For example, in some embodiments, the machine-learning platform system 102 selects a constant value of “1” or “0” even if those values do not reflect a mean of the transformed measured data values.

As shown in FIG. 3, the machine-learning platform system 102 also performs an act 308 of generating the transformed tabular data set. For example, the machine-learning platform system 102 combines the transformed measured tabular data values and the replaced placeholder tabular data values to generate a transformed tabular data set. As shown, the transformed tabular data set (−2, 0.7, 0, 0.07, 0) no longer contains large outlier values, blank values, or high proxy values that will distort a neural network. Rather, the transformed tabular data set reflects data values within a neural network range that accurately reflect variations in data without such wide variations that will disrupt parameters of the neural network during training or implementation.

As mentioned previously, the machine-learning platform system 102 can also generate high-dimensionality tabular data sets. For example, FIG. 4 illustrates the machine-learning platform system 102 generating a high-dimensionality tabular data set 412.

As shown, the machine-learning platform system 102 identifies a numerical value 402. In particular, the machine-learning platform system 102 extracts the numerical value 402 from a transformed tabular data set (e.g., from the transformed tabular data set generated at the act 308). As mentioned, the machine-learning platform system 102 can generate transformed tabular data sets that include numerical values and categorical values. In one or more implementations, the machine-learning platform system 102 extracts the numerical values (and not embedded categorical values) from the transformed tabular data set. For example, even though the machine-learning platform system 102 embeds categorical values using numbers or vectors, the machine-learning platform system 102 can ignore the categorical values and identify entries that began as numerical values (prior to embedding or transformation).

The machine-learning platform system 102 utilizes a projection layer 404 to generate a feature vector 406 in a high-dimensionality feature space (e.g., a high-dimensional feature vector). As discussed previously, the projection layer 404 can include learned weights and parameters that map input values to multi-dimensional feature spaces. For example, the projection layer 404 can include a neural network layer trained to map input values (having a first, single dimension) to a feature vector (having a second, higher dimensionality). For example, the projection layer 404 can generate a feature vector having multiple values defining a coordinate or region in multi-dimensional space (e.g., 3, 4, or 5 dimensional feature space). In some embodiments, the projection layer 404 includes a different type of mapping function, such as a matrix multiplication function that maps an input value into a feature vector of a particular dimensionality. For instance, the projection layer 404 can include a (learned) matrix with various projection sizes (e.g., 5, 8, or 16). In one or more implementations, the machine-learning platform system 102 configures the projection layer 404 in advance (e.g., prior to training). In some embodiments, the machine-learning platform system 102 configures the projection layer at the time of training (e.g., as shown in FIG. 4).

As mentioned, in some implementations, the machine-learning platform system 102 operates with regard to recurrent neural networks or other neural networks that analyze sequence information. In such circumstances, the machine-learning platform system 102 can also embed sequence information into the feature vectors.

As shown in FIG. 4, the machine-learning platform system 102 also utilizes a normalization layer 408 to generate a normalized feature vector 410 from the feature vector 406. Indeed, in some circumstances, the feature vectors 406 can result in a large value, which can cause deviation within the neural network. Accordingly, in one or more implementations, the machine-learning platform system 102 applies the normalization layer to the embedding reflected in the feature vector 406 to reduce the magnitude of the values within the feature vector 406.

In one or more embodiments, the machine-learning platform system 102 utilizes the L2 norm to implement the normalization layer 408. The L2 norm reflects the distance of a vector coordinate from a reference point in vector space. For example, the L2 norm can include the Euclidean distance between a vector coordinate and the origin in the vector space. To illustrate, the machine-learning platform system 102 can determine the L2 norm, |x|, according to the following equation:

$$\vert x \vert = \sqrt{{\sum }_{k = 1}^{n} {\vert {x}_{k} \vert}^{2}}$$

where n reflects the dimensionality of a feature vector, and xₖ represents the kth value of the feature vector.

The machine-learning platform system 102 can apply the L2 norm in a variety of ways. For example, in one or more embodiments, the machine-learning platform system 102 divides the feature vector by the L2 norm to generate the normalized feature vector 410. In other implementations, the machine-learning platform system 102 applies the L2 norm in a different manner (e.g., multiply, as an exponent, or as logarithmic function).

As shown in FIG. 4, the machine-learning platform system 102 utilizes the normalized feature vector 410 to generate the high-dimensionality tabular data set 412. For example, the machine-learning platform system 102 can combine normalized feature vectors for each numerical value in a tabular data set (together with categorical tabular data values) to generate the high-dimensionality tabular data set 412.

Indeed, as mentioned above a tabular data set can include categorical and numerical data values. In some embodiments, the machine-learning platform system 102 performs the process illustrated in FIG. 4 for any numerical values and then combines the resulting feature vectors with categorical features. To illustrate, the machine-learning platform system 102 may have categorical features reflected in one or more embeddings. For example, the machine-learning platform system 102 can generate an embedding for a client device type in a five-dimensional embedding. Similarly, for a numerical feature, such as salary, the machine-learning platform system 102 can utilize the projection layer 404 to generate a five-dimensional embedding for the salary. The machine-learning platform system 102 can then combine the categorical embedding and the numerical embedding into the high-dimensionality data set 412.

Although the foregoing example illustrates a single categorical embedding and a single numerical embedding, the machine-learning platform system 102 can operate with regard to a variety of different categorical features and numerical features. For example, the machine-learning platform system 102 can utilize ten categorical features (with five-dimensional feature embeddings for a total of fifty categorical feature representations) and ten numerical features (with five-dimensional feature embeddings for a total of fifty numerical feature representations). The machine-learning platform system 102 can provide all of these features (e.g., one-hundred feature representations) to a neural network for generating a prediction. In some implementations, the dimensionality of the categorical features may be different than the dimensionality of the numerical features.

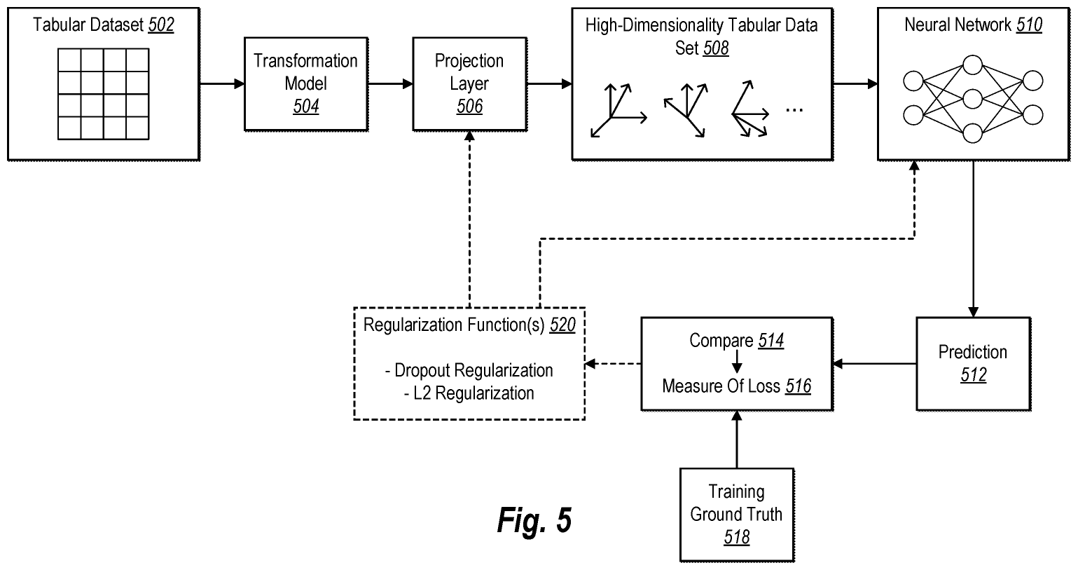

As mentioned previously, in some embodiments, the machine-learning platform system 102 also trains a neural network utilizing transformed/high-dimensionality tabular data sets. For example, FIG. 5 illustrates the machine-learning platform system 102 training a neural network 510 utilizing a (transformed) high-dimensionality tabular data set 508 in accordance with one or more embodiments.

Indeed, as shown, the machine-learning platform system 102 identifies a tabular data set 502 and utilizes a transformation model 504 and projection layer 506 to generate a high-dimensionality tabular data set 508. Indeed, as described in relation to FIGS. 3-4, the machine-learning platform system 102 can modify the tabular data set 502 to increase its sensitivity (e.g., by expanding the dimensionality of numerical values) while correcting placeholder values and limiting variability that would otherwise distort the neural network 510.

As shown, the machine-learning platform system 102 utilizes the neural network 510 to generate a prediction 512. Specifically, the machine-learning platform system 102 processes the high-dimensionality tabular data set 508 through layers of the neural network 510. These layers include weights/parameters that transform the high-dimensionality tabular data set 508 into the prediction 512. In one or more implementations, the neural network 510 is a multi-layer perceptron (e.g., with three layers). In some implementations, the neural network 510 has a different neural network architecture, such as a convolutional neural network.

As shown, the machine-learning platform system 102 can train the neural network 510 by performing an act 514 of comparing the prediction 512 with a training ground truth 518. The training ground truth 518 reflects an actual or measured value corresponding to the prediction 512. Thus, for example, if the prediction 512 reflects a predicted disposition of a client device, the training ground truth 518 reflects the actual disposition of the client device. Similarly, if the prediction 512 reflects a computer security risk prediction (e.g., whether a client device is a security risk), the training ground truth 518 reflects the actual security risk (e.g., an indication that the client devices is a security risk, such as a digital pirate, or not).

The machine-learning platform system 102 compares the prediction 512 and the training ground truth 518 to train the neural network. In particular, the machine-learning platform system 102 compares the prediction and the training ground truth utilizing a loss function. A loss function can determine a measure of loss 516 (e.g., a reflection of difference) between two values or results (e.g., a measure of the difference between the prediction 512 and the training ground truth 518). In some implementations, the machine-learning platform system 102 utilizes a multi-log loss for multi-class classification. The loss function can also include mean absolute error (L1) loss functions, mean squared error (L2) loss functions, cross entropy loss functions, or Kullback-Leibler loss.

The machine-learning platform system 102 trains the neural network 510 based on the comparison between the prediction 512 and the training ground truth 518. For example, the machine-learning platform system 102 can modify internal weights or parameters of the neural network 510 (e.g., via back propagation) to reduce the measure of loss. In this manner, the machine-learning platform system 102 trains the neural network to provide improved predictions.

As shown, the machine-learning platform system 102 can also modify the projection layer 506. For example, the machine-learning platform system 102 can modify internal weights/parameters of the projection layer 506 based on the measure of loss 516. In this manner, the machine-learning platform system 102 can also train the projection layer 506 to generate embeddings (feature vectors) for numerical values that more accurately encode significant features within a multi-dimensional feature space.

In one or more implementations, the machine-learning platform system 102 iteratively performs the training process illustrated in FIG. 5. For example, the machine-learning platform system 102 repeatedly generates predictions and modifies parameters of the neural network 510 to better align the predictions to the training ground truths. In some embodiments, the machine-learning platform system 102 performs a pre-defined number of training iterations and/or trains the neural network 510 until detecting a threshold convergence of the model parameters.

As shown in FIG. 5, in modifying parameters of the neural network 510 and/or the projection layer 506, the machine-learning platform system 102 can also utilize one or more regularization functions 520. A regularization function refers to a computer-implemented model, algorithm, or technique to calibrate machine learning models and prevent overfitting/underfitting. In particular, a regularization function can reduce, penalize, or limit modification of internal parameters in training to avoid overfitting or underfitting to the training data.

In relation to FIG. 5, the machine-learning platform system 102 utilizes two regularization functions: a dropout regularization function and/or an L2 regularization function. A dropout regularization function ignores or drops outputs from some neurons or layers within a neural network. This has the effect of making the training process more noisy, and avoiding overfitting to any particular sample or training batch. Thus, for example, dropout regularization would dropout or block the output of a first layer (or collection of neurons/blocks) in a first training iteration and dropout or block the output of a second layer (or collection of neurons/blocks) in a second training iteration.

Similarly, the machine-learning platform system 102 also utilizes an L2 regularization (or ridge regression). An L2 regression penalizes weights within the neural network. In particular, in one or more embodiments, an L2 regularization adds a squared magnitude of coefficient as a penalty term to the loss function. For instance, the L2 regression adds the sum of squares of feature weights to the loss function to discourage excessively high weights and overfitting.

As mentioned, in some embodiments the machine-learning platform system 102 utilizes both dropout regularization and L2 regularization. Experimenters identified unexpected results in that utilizing both dropout regularization and L2 regularization provided marked improvements in processing tabular data sets utilizing neural networks.

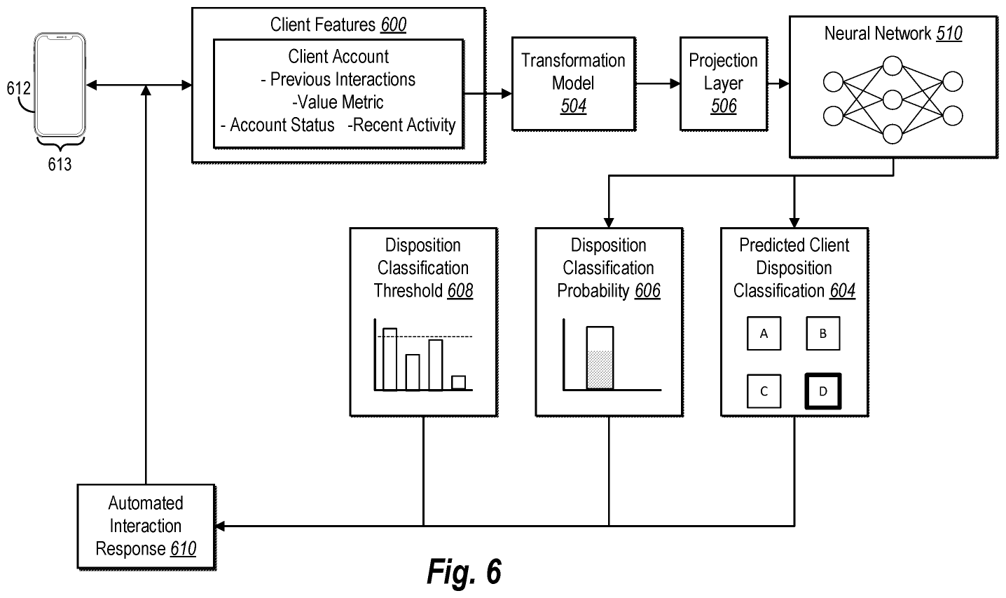

The machine-learning platform system 102 can utilize a trained neural network for a variety of prediction tasks. For example, FIG. 6 illustrates the machine-learning platform system 102 utilizing the neural network 510 to generate predicted client disposition classifications 604 and automated interaction responses 610 (e.g., as part of an interactive voice response system or an automated text chat system).

More specifically, as illustrated in FIG. 6, the machine-learning platform system 102 extracts client features 600 corresponding to a client device 612 and uses the transformation model 504, the projection layer 506, and the neural network 510 to generate a predicted client disposition classification 604 and a disposition classification probability 606. The machine-learning platform system 102 utilizes the predicted client disposition classification 604, the disposition classification probability 606, and a disposition classification threshold 608 to generate and provide the automated interaction response 610.

As just mentioned, the machine-learning platform system 102 extracts client features 600. For example, when the client device 612 contacts an automated client interaction system (e.g., implemented by the server(s) 106), the machine-learning platform system 102 determines the identity of the client device 612 either through a device application 613 or through client provided credentials. In particular, client provided credentials can include social security numbers, caller ID, card numbers, personal identification numbers, and other information related to a digital account.

Upon determining a digital account or identity corresponding to the client device 612, the machine-learning platform system 102 extracts the client features 600 corresponding to a digital account of the client device 612 or the device application 613. For example, the client features 600 can include previous interactions between the client device 612 and the machine-learning platform system 102, a value metric of the digital account, an account status, or recent activity of the digital account. Upon extracting the client features 600, the machine-learning platform system 102 generates a tabular data structure reflecting the client features 600.

As illustrated in FIG. 6, the machine-learning platform system 102 also utilizes the transformation model 504 and the projection layer 506 to generate inputs to the neural network 510. Indeed, as described above in relation to FIGS. 2-4, the machine-learning platform system 102 generates a transformed tabular data set and a high-dimensionality tabular data set. The machine-learning platform system 102 then provides the high-dimensionality tabular data set to the neural network 510.

As shown in FIG. 6, the machine-learning platform system 102 utilizes the neural network 510 to generate the predicted client disposition classification 604. The predicted client disposition classification 604 can include a variety of dispositions or purposes for a client interaction. For example, the machine-learning platform system 102 utilizes the neural network 510 to predict a client device initiating a client interaction (e.g., calling) to activate a card, request information regarding a recent deposit, inquire regarding a recent statement, open a new account, close an account, or some other disposition. Similarly, client disposition classifications can include an account update, direct deposit status (e.g., has an account received a direct deposit), fee information (e.g., information regarding one or more fees associated with the account), check status (e.g., whether or not a check has cleared an account), interaction history (e.g., information regarding recent transactions or other interactions), order status (e.g., status of a particular order or transaction), and activation (e.g., activation of an account, product, card, or service).

In addition to the predicted client disposition classification 604, the neural network 510 also generates the disposition classification probability 606. The disposition classification probability 606 reflects the likelihood that the predicted client disposition classification 604 corresponds to the actual disposition of the client. Thus, if the machine-learning platform system 102 predicts “direct deposit status” as the client device's disposition, the automated client interaction system also generates a corresponding probability (e.g., 85%) as a level of confidence for the actual reason of contact.

In some embodiments, the machine-learning platform system 102 generates a plurality of predicted client disposition classifications and corresponding disposition classification probabilities. For example, the machine-learning platform system 102 can utilize the neural network 510 to generate multiple predicted client disposition classifications with a corresponding probability distribution for the predicted classifications.

Moreover, as shown in FIG. 6, the machine-learning platform system 102 also identifies and utilizes the disposition classification threshold 608. In particular, the machine-learning platform system 102 can utilize the disposition classification threshold 608 to select one or more client dispositions and then generate the automated interaction response 610. To illustrate, the machine-learning platform system 102 can determine the disposition classification threshold 608 of 85%. The machine-learning platform system 102 can then compare disposition classification probabilities (i.e., the disposition classification probability 606) with the disposition classification threshold 608. Thus, if the machine-learning platform system 102 determines that the disposition classification probability 606 (e.g., 86%) satisfies the disposition classification threshold 608 (e.g., 85%) the machine-learning platform system 102 can take a first course of action (e.g., generate the automated interaction response 610). If the machine-learning platform system 102 determines that the disposition classification probability 606 (e.g., 50%) does not satisfy the disposition classification threshold 608 (e.g., 85%) the machine-learning platform system 102 can take a second course of action (e.g., withhold an automated interaction response).

In some implementations, the machine-learning platform system 102 utilizes the predicted client disposition classification with the maximum probability. In some embodiments, the machine-learning platform system 102 uses the predicted client disposition classification that is the maximum probability so long as the probability is greater than a 0.5 disposition classification threshold. Moreover, in one or more embodiments, the machine-learning platform system 102 utilizes the predicted client disposition classification that is the maximum probability so long as the probability is greater than a 0.6 disposition classification threshold.

In some embodiments, the machine-learning platform system 102 does not utilize the disposition classification threshold 608. For example, the machine-learning platform system 102 can utilize a predicted client disposition classification with a highest disposition classification probability 606 to generate the automated interaction response 610.

As illustrated in FIG. 6, the machine-learning platform system 102 provides an automated interaction response 610. For example, the machine-learning platform system 102 generates the automated interaction response 610 based on the disposition classification threshold 608, the disposition classification probability 606, and the predicted client disposition classification 604. As discussed above, the predicted client disposition classification 604 has the corresponding disposition classification probability 606. In particular, if the disposition classification probability 606 satisfies the disposition classification threshold 608 then the machine-learning platform system 102 generates the automated interaction response 610. The machine-learning platform system 102 then provides the automated interaction response 610 to the client device 612. In some implementations, the machine-learning platform system 102 provides a predicted client disposition to an agent device (e.g., the agent device(s) 110b) to assist the client device 612 in accessing pertinent information.

In one or more embodiments, the machine-learning platform system 102 utilizes the neural network to generate predictions as described by UTILIZING MACHINE LEARNING MODELS TO PREDICT CLIENT DISPOSITIONS AND GENERATE ADAPTIVE AUTOMATED INTERACTION RESPONSES, U.S. application Ser. No. 17/554,795, filed Dec. 17, 2021, which is incorporated herein by reference in its entirety.

Although FIG. 6 illustrates a particular application of the neural network 510, the machine-learning platform system 102 can utilize a trained network to generate a variety of predictions in a variety of applications. For example, in some implementations, the machine-learning platform system 102 utilizes the neural network 510 to predict security threats (e.g., predict fraudulent transactions, fraudulent access to client accounts, fraudulent transaction disputes, or other fraudulent conduct) as described by UTILIZING A FRAUD PREDICTION MACHINE-LEARNING MODEL TO INTELLIGENTLY GENERATE FRAUD PREDICTIONS FOR NETWORK TRANSACTIONS, U.S. application Ser. No. 17/546,410, filed Dec. 9, 2021; GENERATING A FRAUD PREDICTION UTILIZING A FRAUD-PREDICTION MACHINE-LEARNING MODEL, U.S. application Ser. No. 17/545,890, filed Dec. 8, 2021; or UTILIZING MACHINE-LEARNING MODELS TO DETERMINE TAKE-OVER SCORES AND INTELLIGENTLY SECURE DIGITAL ACCOUNT FEATURES, U.S. application Ser. No. 17/574,144, filed Jan. 12, 2022, which are incorporated herein by reference in their entirety.

Similarly, in one or more implementations, the machine-learning platform system 102 utilizes the neural network 510 as a risk prediction model that generates activity scores and predicted base limit values for digital accounts as described in GENERATING USER INTERFACES COMPRISING DYNAMIC BASE LIMIT VALUE USER INTERFACE ELEMENTS DETERMINED FROM A BASE LIMIT VALUE MODEL, U.S. application Ser. No. 17/519,129, filed Nov. 4, 2021, and incorporated by reference herein in its entirety.

Moreover, in one or more embodiments, the machine-learning platform system 102 utilizes the neural network training and implementation approach described above as part of a machine learning pipeline, as described in TRAINING AND IMPLEMENTING MACHINE-LEARNING MODELS UTILIZING MODEL CONTAINER WORKFLOWS, U.S. application Ser. No. 17/578,222, filed Jan. 18, 2022, which is incorporated by reference herein in its entirety. Indeed, the machine-learning platform system 102 can utilize the transformation model 504, the projection layer 506, and/or the neural network 510 training and implementation as part of model container workflows as described in U.S. application Ser. No. 17/578,222.

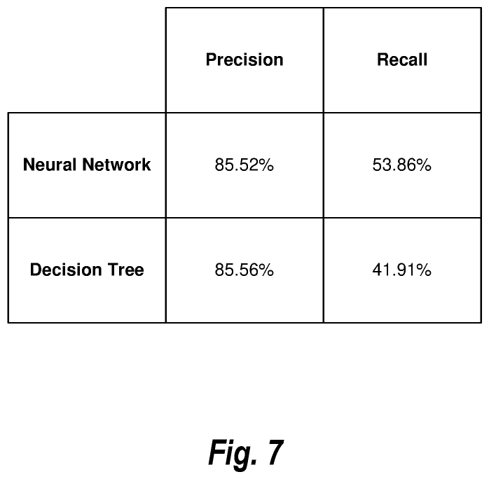

As mentioned above, researchers have conducted experiments to analyze the accuracy of experimental embodiments of the machine-learning platform system 102. For example, FIG. 7 illustrates experimental results of the accuracy of exemplary machine learning model as described herein. As illustrated, researchers measured precision and recall of a decision tree model and an exemplary neural network trained in accordance with one or more embodiments of the machine-learning platform system 102 described herein. As shown, for approximately the same precision (i.e., 85.5%), the machine-learning platform system 102 provides a significant improvement in recall (e.g., 53.86% versus 41.91%). This represents over a 20% increase in recall relative to conventional decision tree approaches.

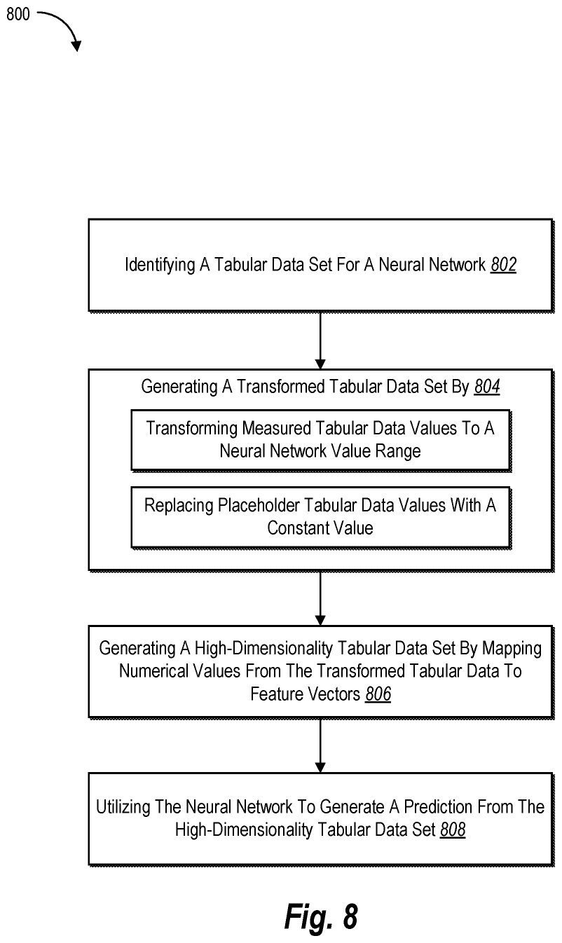

FIGS. 1-7, the corresponding text, and the examples provide a number of different systems, methods, and non-transitory computer readable media for utilizing a neural network and a high-dimensionality tabular data set to generate a prediction. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for utilizing a neural network and a high-dimensionality tabular data to generate a prediction. The series of acts 800 can include an act 802 of identifying a tabular data set for a neural network; an act 804 of generating a transformed tabular data set by: transforming measured tabular data values to a neural network value range; and replacing placeholder tabular data values with a constant value; an act 806 of generating a high-dimensionality tabular data set by mapping numerical values from the transformed tabular data to feature vectors; and an act 808 of utilizing the neural network to generate a prediction from the high-dimensionality tabular data set.

For example, in one or more embodiments, the acts 802-808 include identifying a tabular data set for a neural network comprising measured tabular data values and placeholder tabular data values; generating a transformed tabular data set by: transforming the measured tabular data values to a neural network value range based on a distribution of the measured tabular data values; replacing the placeholder tabular data values with a constant value within the neural network value range; and generating a high-dimensionality tabular data set by mapping, utilizing a projection layer, numerical values from the transformed tabular data set having a first dimensionality to feature vectors having a second dimensionality higher than the first dimensionality; and utilizing the neural network to generate a prediction from the high-dimensionality tabular data set.

To illustrate, in one or more implementations, generating the transformed tabular data set further comprises utilizing a normalization layer to generate normalized feature vectors from the feature vectors having the second dimensionality higher than the first dimensionality.

Furthermore, in one or more embodiments, utilizing the normalization layer to generate the normalized feature vectors comprises dividing the feature vectors having the second dimensionality by L2 norms of the feature vectors.

In one or more embodiments, the series of acts 800 also includes training the neural network by: determining a measure of loss by comparing the prediction to a training ground truth utilizing a loss function; and modifying parameters of the neural network utilizing the measure of loss. Similarly, in one or more implementations, the series of acts 800 includes training the neural network utilizing dropout regularization and L2 regularization.

Moreover, in some implementations, transforming the measured tabular data values to the neural network value range based on the distribution of the measured tabular data values comprises: determining a mean of the measured tabular data values and a deviation metric of the measured tabular data values; and transforming the measured tabular data values to the neural network value range based on the mean and the deviation metric.

In addition, in some embodiments, replacing the placeholder tabular data values with the constant value within the neural network value range comprises replacing the placeholder tabular data values with a transformed mean metric for the measured tabular data values within the neural network value range.

Furthermore, in some implementations, the series of acts 800 includes determining the placeholder tabular data values by identifying unmeasured, proxy tabular data values within the tabular data set.

In one or more embodiments, utilizing the neural network to generate the prediction comprises, utilizing the neural network to generate a predicted client disposition from client features corresponding to a client device, and further comprising, utilizing the predicted client disposition to generate an automated interaction response for the client device. In some implementations, utilizing the neural network to generate the prediction comprises, utilizing the neural network to generate a predicted client disposition from client features corresponding to a client device participating in an automated client interaction, and further comprising, utilizing the predicted client disposition to generate an automated interaction response for the client device.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the client device(s) 110a-110c, or the server(s) 106) that may be configured to perform one or more of the processes described above. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the inter-network facilitation system 104. The network environment 1000 includes a client device 1006 (e.g., the client devices 110a-110c), an inter-network facilitation system 104, and a third-party system 1008 connected to each other by a network 1004. Although FIG. 10 illustrates a particular arrangement of the client device 1006, the inter-network facilitation system 104, the third-party system 1008, and the network 1004, this disclosure contemplates any suitable arrangement of client device 1006, the inter-network facilitation system 104, the third-party system 1008, and the network 1004. As an example, and not by way of limitation, two or more of client device 1006, the inter-network facilitation system 104, and the third-party system 1008 communicate directly, bypassing network 1004. As another example, two or more of client device 1006, the inter-network facilitation system 104, and the third-party system 1008 may be physically or logically co-located with each other in whole or in part.

Moreover, although FIG. 10 illustrates a particular number of client devices 1006, inter-network facilitation systems 104, third-party systems 1008, and networks 1004, this disclosure contemplates any suitable number of client devices 1006, inter-network facilitation system 104, third-party systems 1008, and networks 1004. As an example, and not by way of limitation, network environment 1000 may include multiple client device 1006, inter-network facilitation system 104, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006 and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 10. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1004) to link the third-party-system 1008. For example, the inter-network facilitation system 104 may receive authentication credentials from a user to link a third-party system 1008 such as an online bank account, credit account, debit account, or other financial account to a user account within the inter-network facilitation system 104. The inter-network facilitation system 104 can subsequently communicate with the third-party system 1008 to detect or identify balances, transactions, withdrawal, transfers, deposits, credits, debits, or other transaction types associated with the third-party system 1008. The inter-network facilitation system 104 can further provide the aforementioned or other financial information associated with the third-party system 1008 for display via the client device 1006. In some cases, the inter-network facilitation system 104 links more than one third-party system 1008, receiving account information for accounts associated with each respective third-party system 1008 and performing operations or transactions between the different systems via authorized network connections.

In particular embodiments, the inter-network facilitation system 104 may interface between an online banking system and a credit processing system via the network 1004. For example, the inter-network facilitation system 104 can provide access to a bank account of a third-party system 1008 and linked to a user account within the inter-network facilitation system 104. Indeed, the inter-network facilitation system 104 can facilitate access to, and transactions to and from, the bank account of the third-party system 1008 via a client application of the inter-network facilitation system 104 on the client device 1006. The inter-network facilitation system 104 can also communicate with a credit processing system, an ATM system, and/or other financial systems (e.g., via the network 1004) to authorize and process credit charges to a credit account, perform ATM transactions, perform transfers (or other transactions) across accounts of different third-party systems 1008, and to present corresponding information via the client device 1006.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1008), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1000 either directly or via network 1004. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1004.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1006. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1004. A third-party system 1008 can communicate with the inter-network facilitation system 104 to provide financial information pertaining to balances, transactions, and other information, whereupon the inter-network facilitation system 104 can provide corresponding information for display via the client device 1006. In particular embodiments, a third-party system 1008 communicates with the inter-network facilitation system 104 to update account balances, transaction histories, credit usage, and other internal information of the inter-network facilitation system 104 and/or the third-party system 1008 based on user interaction with the inter-network facilitation system 104 (e.g., via the client device 1006). Indeed, the inter-network facilitation system 104 can synchronize information across one or more third-party systems 1008 to reflect accurate account information (e.g., balances, transactions, etc.) across one or more networked systems, including instances where a transaction (e.g., a transfer) from one third-party system 1008 affects another third-party system 1008.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying a tabular data set for a neural network comprising measured tabular data values and placeholder tabular data values;
generating a transformed tabular data set by:
transforming the measured tabular data values to a neural network value range based on a distribution of the measured tabular data values; and
replacing the placeholder tabular data values with a constant value within the neural network value range;
generating a high-dimensionality tabular data set by mapping, utilizing a projection layer, numerical values from the transformed tabular data set having a first dimensionality to feature vectors having a second dimensionality higher than the first dimensionality; and
utilizing the neural network to generate a prediction from the high-dimensionality tabular data set.

2. The computer-implemented method of claim 1, wherein generating the transformed tabular data set further comprises utilizing a normalization layer to generate normalized feature vectors from the feature vectors having the second dimensionality higher than the first dimensionality.

3. The computer-implemented method of claim 2, wherein utilizing the normalization layer to generate the normalized feature vectors comprises dividing the feature vectors having the second dimensionality by L2 norms of the feature vectors.

4. The computer-implemented method of claim 1, further comprising training the neural network by:
determining a measure of loss by comparing the prediction to a training ground truth utilizing a loss function; and
modifying parameters of the neural network utilizing the measure of loss.

5. The computer-implemented method of claim 4, further comprising training the neural network utilizing dropout regularization and L2 regularization.

6. The computer-implemented method of claim 1, wherein transforming the measured tabular data values to the neural network value range based on the distribution of the measured tabular data values comprises:
determining a mean of the measured tabular data values and a deviation metric of the measured tabular data values; and
transforming the measured tabular data values to the neural network value range based on the mean and the deviation metric.

7. The computer-implemented method of claim 1, wherein replacing the placeholder tabular data values with the constant value within the neural network value range comprises replacing the placeholder tabular data values with a transformed mean metric for the measured tabular data values within the neural network value range.

8. The computer-implemented method of claim 1, further comprising determining the placeholder tabular data values by identifying unmeasured, proxy tabular data values within the tabular data set.

9. The computer-implemented method of claim 1, wherein utilizing the neural network to generate the prediction comprises, utilizing the neural network to generate a predicted client disposition from client features corresponding to a client device participating in an automated client interaction, and further comprising, utilizing the predicted client disposition to generate an automated interaction response for the client device.

10. A non-transitory computer-readable medium storing instructions that, when executed by at least one processor, cause a computer system to:
identify a tabular data set for a neural network comprising measured tabular data values and placeholder tabular data values;
generate a transformed tabular data set by:
transforming the measured tabular data values to a neural network value range based on a distribution of the measured tabular data values; and
replacing the placeholder tabular data values with a constant value within the neural network value range;
generate a high-dimensionality tabular data set by mapping, utilizing a projection layer, numerical values from the transformed tabular data set having a first dimensionality to feature vectors having a second dimensionality higher than the first dimensionality; and
utilize the neural network to generate a prediction from the high-dimensionality tabular data set.

11. The non-transitory computer-readable medium of claim 10, wherein the instructions, when executed by the at least one processor, further cause the computer system to generate the transformed tabular data set by utilizing a normalization layer to generate normalized feature vectors from the feature vectors having the second dimensionality higher than the first dimensionality.

12. The non-transitory computer-readable medium of claim 11, wherein utilizing the normalization layer to generate the normalized feature vectors comprises dividing the feature vectors having the second dimensionality by L2 norms of the feature vectors.

13. The non-transitory computer-readable medium of claim 10, wherein the instructions, when executed by the at least one processor, further cause the computer system to train the neural network by:
determining a measure of loss by comparing the prediction to a training ground truth utilizing a loss function; and
modifying parameters of the neural network utilizing the measure of loss.

14. The non-transitory computer-readable medium of claim 13, wherein the instructions, when executed by the at least one processor, further cause the computer system to train the neural network utilizing dropout regularization and L2 regularization.

15. The non-transitory computer-readable medium of claim 10, wherein the instructions, when executed by the at least one processor, further cause the computer system to replace the placeholder tabular data values with the constant value within the neural network value range by replacing the placeholder tabular data values with a transformed mean metric for the measured tabular data values within the neural network value range.

16. A system comprising:
at least one processor; and
at least one non-transitory computer-readable storage medium storing instructions that, when executed by the at least one processor, cause the system to:
identify a tabular data set for a neural network comprising measured tabular data values and placeholder tabular data values;
generate a transformed tabular data set by:
transforming the measured tabular data values to a neural network value range based on a distribution of the measured tabular data values; and
replacing the placeholder tabular data values with a constant value within the neural network value range;
generate a high-dimensionality tabular data set by mapping, utilizing a projecting layer, numerical values from the transformed tabular data set having a first dimensionality to feature vectors having a second dimensionality higher than the first dimensionality; and
utilize the neural network to generate a prediction from the high-dimensionality tabular data set.

17. The system of claim 16, further comprising instructions that, when executed by the at least one processor, cause the system to generate the transformed tabular data by dividing the feature vectors having the second dimensionality by L2 norms of the feature vectors.

18. The system of claim 16, further comprising instructions that, when executed by the at least one processor, cause the system to train the neural network by:
determining a measure of loss by comparing the prediction to a training ground truth utilizing a loss function; and
modifying parameters of the neural network utilizing the measure of loss.

19. The system of claim 16, further comprising instructions that, when executed by the at least one processor, cause the system to replace the placeholder tabular data values with the constant value within the neural network value range by replacing the placeholder tabular data values with a transformed mean metric for the measured tabular data values within the neural network value range.

20. The system of claim 16, further comprising instructions that, when executed by the at least one processor, cause the system to:
identify the tabular data set for the neural network by extracting client features corresponding to a client participating in an automated client interaction; and
utilize the neural network to generate the prediction by utilizing the neural network to generate a predicted client disposition from the client features, and further comprising, utilizing the predicted client disposition to generate an automated interaction response.
